(19) United States
(12) Patent Application Publication
(10) Pub. No.: US 2020/0248503 A1
(43) Pub. Date: Aug. 6, 2020

(54) A Light Regulating System and Operating Method Therefor

(71) Applicant: Kindow B.V., Delft (NL)

(72) Inventors: Sam KIN, Amsterdam (NL); Laurentius Jacobus Theodorus PAAUWEN, Delft (NL); Koen Erjan VAN HEES, Delft (NL); Ritske Johannes VAN LEEUWEN, Delft (NL)

(21) Appl. No.: 16/757,521

(22) PCT Filed: Oct. 17, 2018
(86) PCT No.: PCT/NL2018/050681

§ 371 Date: Apr. 20, 2020

(30) Foreign Application Priority Data
Oct. 19, 2017 (NL) NL2019766

(51) Int. Cl. E06B 9/36

(52) U.S. Cl. CPC E06B 9/364; E06B 9/368

(57) ABSTRACT

This invention relates to a light regulating system comprising a rail, a plurality of lamellae, lamellae support members, a lamellae rotating actuator system, a measurement system, a detector, and a control unit, wherein an operating member is connected to the lamellae rotating actuator system to allow rotation of the lamellae by manual operation of the operating member, and wherein the control unit is configured to operate in a main automatic mode in which the lamellae rotating actuator system is autonomously driven, provided that the detector indicates that the lamellae support members are in a closed position and there is no indication from the measurement system that the lamellae have been rotated by a user.

### BACKGROUND OF THE INVENTION

The invention relates to a system to be used in windows or window like façade structures to selectively block external light using vertical blinds, lamellae or slats.

Such a system comes in different configurations. Commonly known are the manually operated vertical blinds in which the position of the vertical blinds along a horizontal rail and/or the angular orientation of the blinds about a respective vertical rotation axis can be manually set and adjusted. An advantage is that the systems can be designed compact and light weighted. A drawback of the manually operated vertical blinds is that it requires regular adjustment due to an ever changing position of the sun and/or weather conditions.

It has therefore been proposed in the past to automate the vertical blinds systems. An example thereof is disclosed in international patent publication WO2015/119503A1 in which a device is disclosed to automatically orient slats relative to the sun.

A drawback of the automatic devices is that there are situations in which the orientation of the slats is not as required. Further, the devices are generally relatively heavy and space-consuming.

### BRIEF SUMMARY OF THE INVENTION

In view of the above it is an object of the invention to provide a system combining at least some of the advantages of the manually and automatically operated vertical blinds without interfering with each other.

According to a first aspect of the invention, there is provided a light regulating system comprising:
a rail, in use extending in horizontal direction;
a plurality of lamellae, in use extending in vertical direction;
lamellae support members to support the plurality of lamellae, wherein the lamellae support members are movably connected to the rail allowing to move the lamellae support members along the rail parallel to a longitudinal axis of the rail between an open position in which the lamellae support members are stacked together and a closed position in which the lamellae support members are distributed substantially evenly along the rail, and wherein each lamellae support member is attached to a corresponding lamella such that the respective lamella can rotate relative to the rail about a rotation axis extending parallel to a longitudinal axis of the lamella;
a lamellae rotating actuator system configured to rotate the lamellae about their respective rotation axes;
a measurement system configured to measure an actual angular orientation of the lamellae about their respective rotation axes;
a detector configured to detect whether or not the lamellae support members are in the closed position;
a control unit configured to drive the lamellae rotating actuator system based on a comparison of the actual angular orientation of the lamellae as measured by the measurement system and a desired angular orientation of the lamellae as determined by the control unit based on a position and/or intensity of the sun;
   wherein an operating member is connected to the lamellae rotating actuator system to allow rotation of the lamellae about their respective rotation axes by manual operation of the operating member, wherein the detector and the measurement system are connected to the control unit, wherein the control unit comprises a main automatic mode in which the control unit is configured to autonomously drive the lamellae rotating actuator system,
   and wherein the control unit is configured to operate in the main automatic mode provided that the detector indicates that the lamellae support members are in the closed position and there is no indication from the measurement system that the lamellae have been rotated by a user since the lamellae support members have been positioned in the closed position or since the control unit started operating in the main automatic mode.

In the context of this patent specification, manual operation, manual control, manual mode or manually means that an external force applied by hands or other human body parts is the driving force behind the corresponding operation and not a motor or actuator. This is in contrast to electronically controlled systems in which operation is based on user input provided via an electronic control interface, and in which the force applied by a motor or actuator is the driving force behind the corresponding operation. Such a mode will be referred to as user control mode.

An advantage of the system according to the first aspect of the invention is that both automatic control and manual control are possible without interfering with each other. This is due to the fact that in the main automatic mode the control unit checks for the presence of user override. Manually rotating the lamellae will indicate to the control unit that automatic control in accordance with the main automatic mode is overruled and will be resumed at a later stage. Hence, automatic control is not interfering with the manual control.

In an embodiment, the operating member is further arranged to manually move the lamellae support members between open and closed positions. Alternatively or additionally, a lamellae translating actuator system may be provided and configured to move the lamellae support members between open and closed positions based on user input, e.g. provided via an electronic control interface.

Independent of the operating method for moving the lamellae support members between open and the closed positions, the main automatic mode checks whether the lamellae support members are in the closed position. The main automatic mode thus only functions and continues to function when the lamellae support members are in the closed position and the rotation of the lamellae is only caused by the lamellae rotating actuator system being driven by the control unit without user input. When the operating member is operated to manually rotate the lamellae, this rotation is detected by the measurement system and the control unit ceases to operate in the main automatic mode to prevent interference between the manual operation of the operating member and the main automatic mode. If this would not be the case, the automatic mode would overrule the manual operation of the user and return the angular orientation of the lamellae to the desired angular orientation as determined by the control unit.

The system according to the first aspect of the invention is further different from obvious solutions such as providing control units that either function autonomously or based on user input, so that user control is also provided via the control unit thereby preventing interference between user control and automatic control. An advantage of the system according to the first aspect of the invention—and a disadvantage of the obvious solutions described above—is that manual operation is still possible when the control unit is malfunctioning, removed for maintenance or repair, lacking power, or when a user has no electronic control interface at hand.

In an embodiment, the control unit comprises a manual mode in which the control unit is idle, wherein the control unit is configured to operate in the manual mode when the measurement system indicates that the lamellae have been rotated manually since a specific time instant. Idle thus means that the control unit may be active but refrains from sending driving signals to the lamellae rotating actuator system. In this configuration, the measurement system detects a rotation of the lamellae when being operated in another mode, e.g. the main automatic mode, and the control unit determines whether this rotation is due to the control unit driving the lamellae rotating actuator system or due to manual operation. In case the rotation is determined to be due to manual operation, because the control unit hasn't sent any corresponding driving signals to the lamellae rotating actuator system to rotate the lamellae, the control unit goes idle in accordance with the manual mode in order to keep from interfering with a desired angular orientation of the lamellae set by a user.

In an embodiment, the control unit is configured to operate in the manual mode when the detector alternatively or additionally indicates that the lamellae support members are in an open position. In this configuration, the control unit goes idle when the control unit determines from the output of the detector that the lamellae support members are no longer in the closed position. The purpose of going into manual mode on the basis of the output of the detector may be to prevent the lamellae from interfering with each other, e.g. resulting in damage to the lamellae, as at least some of the lamellae get closer to each other when the lamellae support members are in an open position.

In an embodiment, the control unit comprises a user control mode in which the lamellae rotating actuator system is controllable based on user input provided via an electronic control interface and is also controllable via manual operation of the operating member.

A difference between the manual mode and the user control mode is that the control unit is not idle. Hence, driving signals may still be send by the control unit to the lamellae rotating actuator system to rotate the lamellae support members, but these driving signals are then caused by user input. The lamellae support members may further be rotated manually using the operating member if desired or necessary.

In an embodiment, the control unit comprises an auxiliary automatic mode in which the control unit is configured to autonomously drive the lamellae rotating actuator system, wherein the control unit is configured to operate in the auxiliary automatic mode provided that the detector indicates that the lamellae support members are in an open position and there is no indication from the measurement system that the lamellae have been rotated by a user since the lamellae support members have been positioned in an open position, and wherein the control unit in the auxiliary automatic mode is configured to drive the lamellae rotating actuator system such that the lamellae do not interfere with each other. Hence, control is such that the angular orientation of the lamellae is limited to a range in which the lamellae do not interfere with each other. At the end of the limited range, the lamellae may be relatively quickly rotated in opposite direction to return to the opposite end of the limited range to continue for instance sun tracking.

Above, four modes of operation of the control unit have been described, but the system may be configured to only use the main automatic mode in combination with one or more of the other modes. Examples of different configurations will be described below in more detail.

In a first configuration, the main automatic mode is only combined with the manual mode. Hence, when the lamellae support members are in the closed position, the control unit can be operated in the main automatic mode as long as there is no indication from the measurement system that the lamellae have been rotated by a user since the lamellae support members have been positioned in the closed position or since the control unit started operating in the main automatic mode. The control unit then switches to the manual mode when the lamellae are rotated by a user and/or when the lamellae support members are moved to an open position.

The control unit may be configured to return to the main automatic mode upon receiving a signal from the detector that the lamellae support members have been moved back from an open position to the closed position. Hence, when the control unit entered the manual mode as a result of user initiated rotation of the lamellae only, returning to the main automatic mode may involve moving the lamellae support members from the closed position to an open position first and subsequently moving the lamellae support members from said open position back to the closed position.

Alternatively or additionally, the control unit may be configured to return to the main automatic mode after a predetermined time period or at a predetermined time instant, e.g. during the night, provided the lamellae support members are in the closed position.

In a second configuration, the main automatic mode is only combined with the user control mode. The user control mode then replaces the manual mode compared to the first configuration due to the possibility of providing user input via an electronic control interface to the control unit to rotate the lamellae. Switching between main automatic mode and user control mode may be similar to switching between main automatic mode and manual mode already described above.

In a third configuration, the main automatic mode is combined with the manual mode and the auxiliary mode. When the control unit is operating in main automatic mode, two user actions can take place, namely rotating of the lamellae and moving the lamellae support members to an open position. Rotating the lamellae will cause the control unit to switch to the manual mode and moving the lamellae support members will cause the control unit to switch to the auxiliary automatic mode. Hence, when the lamellae are rotated first, the control unit will switch from the main automatic mode to the manual mode. However, when the lamellae support members are moved first, the control unit will switch from the main automatic mode to the auxiliary automatic mode. Subsequently rotating the lamellae will then cause the control mode to switch from the auxiliary automatic mode to the manual mode.

In the third configuration, the control unit may be configured to return to the main automatic mode from either the manual mode or the auxiliary automatic mode upon receiving a signal from the detector that the lamellae support members have been moved to the closed position.

Alternatively or additionally, the control unit may be configured to switch to another mode after a predetermined time period or at a predetermined time instant, e.g. during the night. Hence, when the control unit is in the manual mode and the lamellae support members have meanwhile been moved to the closed position, the control unit will move back to the main automatic mode upon expiry of the predetermined time period or at the predetermined time instant. In case the lamellae support members have not been moved to the closed position, the control unit will first switch from the manual mode to the auxiliary automatic mode and subsequently to the main automatic mode when moving the lamellae support members to the closed position.

In a fourth configuration, the main automatic mode is combined with the user control mode and the auxiliary automatic mode. The user control mode then replaces the manual mode compared to the third configuration due to the possibility of providing user input via an electronic control interface to the control unit to rotate the lamellae. Switching between main automatic mode, auxiliary automatic mode and user control mode may be similar to switching between main automatic mode, auxiliary automatic mode and manual mode already described above

In an embodiment, the system comprises a lamellae translating actuator system to move the lamellae support members between open position and closed positions, wherein the control unit is configured to drive the lamellae translating actuator system based on user input provided via an electronic control interface.

Hence, the lamellae translating actuator system may be manually operable using an operating member, may be operable using the control unit and an electronic control interface, or both.

Although throughout the specification only a single operating member is mentioned or described, as is preferred, the invention is not limited to a single operating member only. It is also possible that a lamellae rotating operating member is provided for manually rotating the lamellae and a separate lamellae translating operating member is provided for manually translating the lamellae. Further, an operating member may be a stick, cord or any other manually operable device. However, a single operating member, e.g. in the form of a stick, is preferred.

In an embodiment, the operating member is a stick with one end connected to the lamellae rotating actuator system and with the opposite end being free for user operation. Preferably, the free end comprises an intermediate portion and an end portion, wherein the intermediate portion is rotatably connected to the remainder of the operating member to rotate about a first rotation axis, and wherein the end portion is rotatably connected to the intermediate portion to rotate about a second rotation axis, in which the first and second rotation axis are parallel to each other, and in which the operating member has a rest position in which the operating member has a stick shape, and an operating position in which the intermediate portion is rotated substantially perpendicular to the remainder of the operating member and the end portion is at a distance of and substantially parallel to the remainder of the operating member thereby allowing to apply a larger moment to the operating member via the end portion. And advantage thereof is that the force a user needs to apply to rotate the lamellae decreases.

In an embodiment, the lamellae are able to rotate 360 degrees about their respective rotation axis without interfering with neighboring lamellae in the closed position of the lamellae support members. Advantages of this embodiment may be:
unhindered rotation of the lamellae preventing any damage to the lamellae;
possibility to continuously follow the sun to block direct sunlight without having to rotate the lamellae substantially 180 degrees when the lamellae get into an orientation substantially parallel to each other; and/or
possibility to use lamellae having two different surfaces wherein in all angular positions of the lamellae, the user has the choice to select one of the surfaces to face inwards or outwards. In an example, one surface is reflective while the other one has light absorbing properties, so that for instance in the winter the light absorbing surface can be positioned towards the sun to harvest heat and in the summer the light reflective surface can be positioned towards the sun to repel heat.

In an embodiment, when the lamellae overlap, also in the closed position, and thus are not able to freely rotate 360 degrees, the control unit in the main automatic mode is configured to drive the lamellae rotating actuator system such that the lamellae do not interfere with each other. Hence, control is such that the angular orientation of the lamellae is limited to a range in which the lamellae do not interfere with each other. At the end of the limited range, the lamellae may be relatively quickly rotated in opposite direction to return to the opposite end of the limited range to continue for instance sun tracking.

In an embodiment, the measurement system is configured to measure an absolute angular orientation of the lamellae. In this way the correct angular orientation of the lamellae can be measured, even after a shutdown or manual rotation of the lamellae.

In an embodiment, the lamellae rotating actuator system is arranged at a first side of the rail, wherein the lamellae support members in the open position are arranged, i.e. stacked together, at a second side of the rail opposite to the first side of the rail. This is advantageous, because it allows to arrange the detector also at the first side of the rail. When also the measurement system, operating member, control unit, and possibly the lamellae translating actuator system are arranged at the first side of the rail, all critical components for operating the lamellae support members and lamellae are arranged at the first side of the rail allowing for a compact system. This allows for instance to efficiently provide power and/or data to the system.

In an embodiment, the system further comprises a retainer configured to apply a biasing force to the lamellae support members when the lamellae support members are in the closed position, so that the lamellae support members can only be moved to an open position when a force is applied to the lamellae support members that is larger than and opposite to the biasing force. This allows a steady closed position and a proper and reliable detection of the closed position of the lamellae support members as there is a biasing force keeping the lamellae support members in the closed position. In an embodiment, the retainer comprises a magnet to apply the biasing force.

In an embodiment, the lamellae rotating actuator system comprises a motor and a lamellae support member engaging element connected to the motor and engaging with the lamellae support members, wherein the operating member is connected to the lamellae support member engaging element, such that the lamellae support member engaging element can be driven to rotate the lamellae support members via the motor and via the operating member.

In an embodiment, the lamellae rotating actuator system comprises a decoupler configured to decouple the operating member from the motor when operating the operating member manually. The decoupler may be a slip clutch or any other type of clutch, and allows to manually rotate the lamellae without having to rotate the motor as well and thus makes manual operation easy and light. The decoupler may also be embodied as a torque limiter or overload clutch, wherein decoupling also includes partially decoupling the load to limit the torque. In an embodiment, the load is decoupled entirely by the decoupler.

In an embodiment, the lamellae rotating actuator system, the measurement system, the detector, and the lamellae translating actuator system, if applicable, are arranged inside or on the rail. In an embodiment, the control unit may be arranged inside or on the rail.

In an embodiment, the system further comprises connecting members allowing to exchange power and/or data with another system according to the first aspect of the invention. This allows to assemble a plurality of systems next to each other and to provide power only to one of the systems, because this system is able to provide power to the next system which in turn is able to provide power to the next system, etc. The same principle can be applied with respect to the exchange of data.

In an embodiment, especially when the system comprises connecting members as described above, the rail comprises a space extending from the first side of the rail to the second side of the rail allowing to accommodate wiring between the first side of the rail and the second side of the rail to transfer power and/or data. The space is preferably invisible from the outside when the rail is mounted to a structure, e.g. a ceiling, so that the wiring is hidden.

In an embodiment, the system further comprises a solar cell to harvest power from light incident to the solar cell, and a battery to store power from the solar cell in order to provide power to the system. In this way, the system has its own autonomous power source. The generated power from the solar cell can further be used to determine whether there is direct sunlight present or only indirect light.

In an embodiment, the system comprises a solar cell to measure light intensity. The solar cell may be the same solar cell described above to harvest power from light. By measuring the intensity of solar irradiance as well as a detection of low-light levels, i.e. absence of direct incident light, it is possible to let the control unit automatically determine that blocking of light is necessary or not and thus in case of low-light levels allows to rotate the lamellae to a position to allow maximum view and daylight.

In an embodiment, the control unit comprises a blocking function for use in the main automatic mode and the auxiliary automatic mode, if applicable, in which the control unit is configured to drive the lamellae rotating actuator system such that the lamellae are directed towards the sun. This is alternatively referred to as tracking the sun or solar tracking. In this function the lamellae always face towards the sun, so that direct sun light is effectively blocked while maintaining a lot of view between the lamellae.

In an embodiment, the control unit comprises a blocking function for use in the main automatic mode and the auxiliary automatic mode, if applicable, in which the control unit is configured to drive the lamellae rotating actuator system such that the lamellae are directed towards the sun when the light intensity as measured by the solar cell is above a first predetermined value, and wherein the control unit comprises an open function for use in the main automatic mode, and auxiliary automatic mode, if applicable, in which the control unit is configured to drive the lamellae rotating actuator system such that the normal to the surfaces of the lamellae are parallel to the longitudinal axis of the rail when the light intensity as measured by the solar cell is below a second predetermined value, wherein preferably the first predetermined value is equal to the second predetermined value. In this way, the control unit is able to switch between the blocking function and the open function based on the intensity of light, such that the lamellae track the sun in case of direct sunlight, but open completely when there is only indirect light. Tracking the sun is thus only done when there is a sun visible to track.

In an embodiment, the control unit comprises a heating function for use in the main automatic mode and the auxiliary automatic mode, if applicable, in which the control unit is configured to drive the lamellae rotating actuator system such that the lamellae are parallel to the sunlight. In this way of tracking the sun, maximum light is allowed to enter a building, room or space, thereby allowing to harvest a maximum of solar heat in the building, room or space, e.g. in the winter. This heating function is preferably activated when there are no users in the building, room or space, e.g. in a weekend for office buildings, so that this function does not interfere with occupants comfort. It is also possible to connect the control unit to a motion detector or similar sensor to detect the presence of people and thus to determine whether the heating function can be activated or not.

In an embodiment, the control unit comprises a maximum view function for use in the main automatic mode and the auxiliary automatic mode, if applicable, in which the control unit is configured to drive the lamellae rotating actuator system such that direct sunlight is prevented from passing the lamellae while at the same time the shadow of a lamella on an adjacent lamella is minimized to get a maximum view in between the lamellae. This maximum view function may be used as an alternative for the blocking function described above, but may also be provided as an additional function.

Tracking, whether using the blocking function, the heating function or the maximum view function, may be done based on an actual measurement of the position of the sun, but may alternatively be based on a calculated position of the sun based on date, time, orientation of the system and geographic location of the system.

In an embodiment, the system further comprises a communication unit connected to the control unit to allow communication, preferably wirelessly, between the control unit and an external device, e.g. an electronic user interface, a monitoring system, a server, a remote control or any other kind of device, including but not limited to smartphones, tablets, computers, etc.

In an embodiment, the control unit comprises a night function for use in the main automatic mode and the auxiliary automatic mode, if applicable, in which the control unit is configured to rotate the lamellae to an angular orientation in which the lamellae are substantially parallel to the longitudinal axis of the rail. With the night function no view is possible between the lamellae making this function particularly useful during the night to increase privacy which may be compromised due to the use of indoor lights. However, the night function may be used any time of the day, e.g. for privacy reasons or to be used during a presentation.

The night function may be used next to any of the other functions and may for instance be activated using a solar cell that is able to determine an outdoor light level and thus able to determine whether the sun has gone down.

In an embodiment, the lamellae rotating actuator system comprises a decoupler configured to decouple the lamellae support member engaging element from the motor and/or operating member when a predetermined torque is applied to the decoupler. Hence, the decoupler may be embodied as a torque limiter or overload clutch, wherein decoupling also includes partially decoupling the load to limit the torque. In an embodiment, the load is decoupled entirely by the decoupler.

The decoupler may be advantageous when for instance the lamellae interfere with each other or with other objects, e.g. objects placed in the moving path of the lamellae by people, for instance a book or folder positioned in the window, and damage is likely to arise. When the motor or operating member is driving the lamellae via the lamellae support member engaging element and the torque rises as a result of interference, further rotation of the lamellae and thus damage is prevented by decoupling the motor and/or operating member from the lamellae support member engaging element.

It is preferred that the decoupler and the measurement system are configured and arranged such that the decoupler is not interfering with the measurement system and thus the measurement is able to measure the actual angular orientation of the lamellae about their respective rotation axes independent of decoupling or not.

In an embodiment, the control unit is configured to detect decoupling caused by the decoupler and to subsequently cease driving the motor in response to detecting decoupling. The control unit may be configured to detect decoupling by comparing an expected rotation of the lamellae caused by driving the motor with the actual rotation of the lamellae as measured by the measurement system and to stop driving the motor when the deviation between expected rotation and actual rotation exceeds a predetermined value. Preferably, a warning signal is also provided to inform a user that decoupling has occurred and that the lamellae are not free to rotate. This may help a user to solve the problem.

A decoupler between the lamellae support member engaging element and the motor also has an advantage over individual decouplers per lamella as are sometimes used in the prior art. With the decoupler between the lamellae support member engaging element and the motor the mutual orientation of the lamellae can be fixed, so that interference of rotation of one or more lamellae causing decoupling by the decoupler affects all lamellae. As a result thereof the measurement system only requires to measure the angular orientation of one lamella to know the angular orientations of the other lamellae as well.

In an embodiment, the decoupler is arranged, and the operating member is connected to the lamellae support member engaging element such that the decoupler is also provided to decouple the operating member from the motor when operating the operating member manually as described earlier. Decoupling may in this embodiment be caused by interference of rotation of the lamellae or by manual operation of the operating member. The control unit may be configured to distinguish the two causes as interference of rotation of the lamellae can be easily detected during driving of the motor and manual operation of the operating member usually takes place when the motor is not driven, so that a deviation between expected angular orientation and actual angular orientation during driving of the motor will be attributed to interference of the rotation of the lamellae and driving of the motor will be stopped, and a deviation between expected angular orientation and actual angular orientation when the motor is not driven will be attributed to manual operation and the control unit will be put in manual mode.

However, separate decouplers may also be used with the advantage that different torques can be set for decoupling allowing to optimize the two situations. It may for instance be beneficial to set decoupling for the operating member at a relatively low torque level, so that manual rotating the lamellae using the operating member is relatively easy while the decoupling to avoid damage may be set at a relatively high torque level sufficient to prevent damage but allowing the system to function normally in all other cases. In an embodiment, a damping element or material is arranged between the motor of the lamellae rotating actuator system and the rail to attenuate vibrations originating from the motor and travelling to the rail. As a result thereof, operation of the motor will make less sound.

According to a second aspect of the invention there is provided a combination of at least two light regulating systems according to the first aspect of the invention, wherein at least one light regulating system carries a cable for transferring power and/or data to at least one other light regulating system.

According to a third aspect of the invention there is provided a method of operating a light regulating system according to the first aspect of the invention comprising the following steps:
a) operating the control unit in the main automatic mode;
b) detecting manual operation of the lamellae rotating actuator system; and
c) subsequently cease operating the control unit in the main automatic mode.

Features and embodiment described in relation to the first aspect of the invention can readily be combined with the second and/or third aspect of the invention as well, where applicable, to avoid unduly repetition of the features and embodiments here. As an example, step c) of the method does not define which mode applies when the control unit cease operating in the main automatic mode, but this may be the manual mode, user control mode, auxiliary automatic mode, etc., as described above with respect to the first aspect of the invention.

### BRIEF DESCRIPTION OF THE DRAWINGS

The invention will now be described in a non-limiting way with reference to the accompanying drawings in which like parts are indicated by like reference symbols and in which:

FIG. 1 schematically depicts a light regulating system according to an embodiment of the invention with the lamellae in an open position;

FIG. 2 schematically depicts the system of FIG. 1 with the lamellae in the closed position;

FIG. 3 schematically depicts a cross-sectional bottom view of the system of FIG. 1;

FIG. 4 depicts a detail of the view of FIG. 3;

FIG. 5 schematically depicts another cross-sectional view of the system of FIG. 1;

FIGS. 6-8 schematically depict bottom views of the system of FIG. 1 with the lamellae in different angular orientations;

FIG. 9 schematically depicts the arrangement of two systems of FIG. 1 next to each other;

FIG. 10 schematically depicts a top view of the view of FIG. 9; and

FIG. 11 schematically depicts a light regulating system according to another embodiment of the invention.

### DETAILED DESCRIPTION OF THE INVENTION

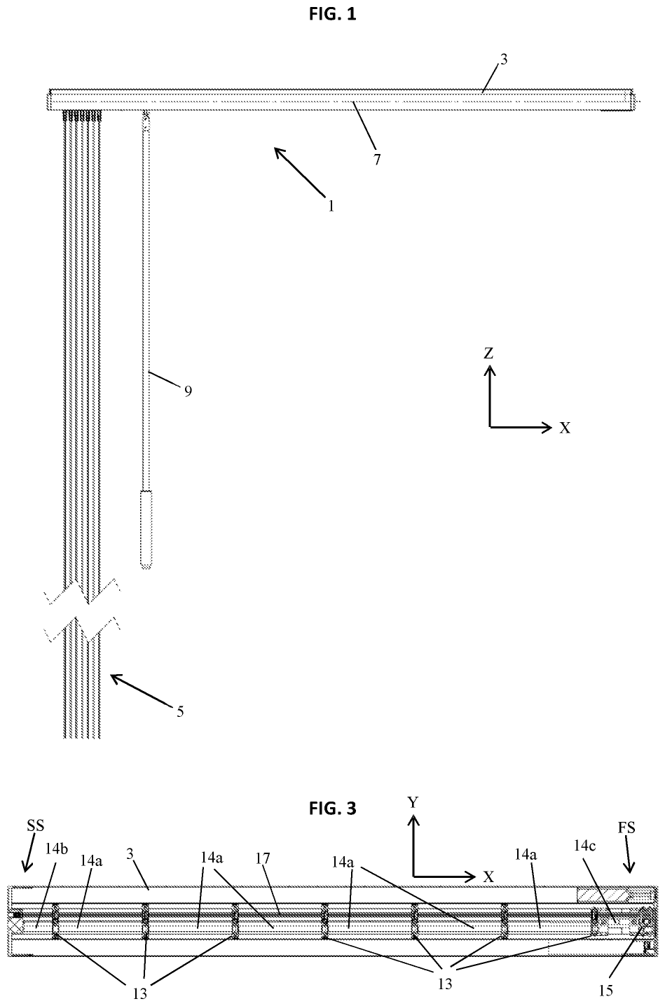

FIGS. 1-8 schematically depict a light regulating system 1 according to an embodiment of the invention. The light regulating system 1 comprises a rail 3, in use extending in horizontal direction, i.e. here in X-direction, and a plurality of lamellae 5, in use extending in vertical direction, i.e. here in Z-direction. Hence, the lamellae 5 extend perpendicular to the rail 3.

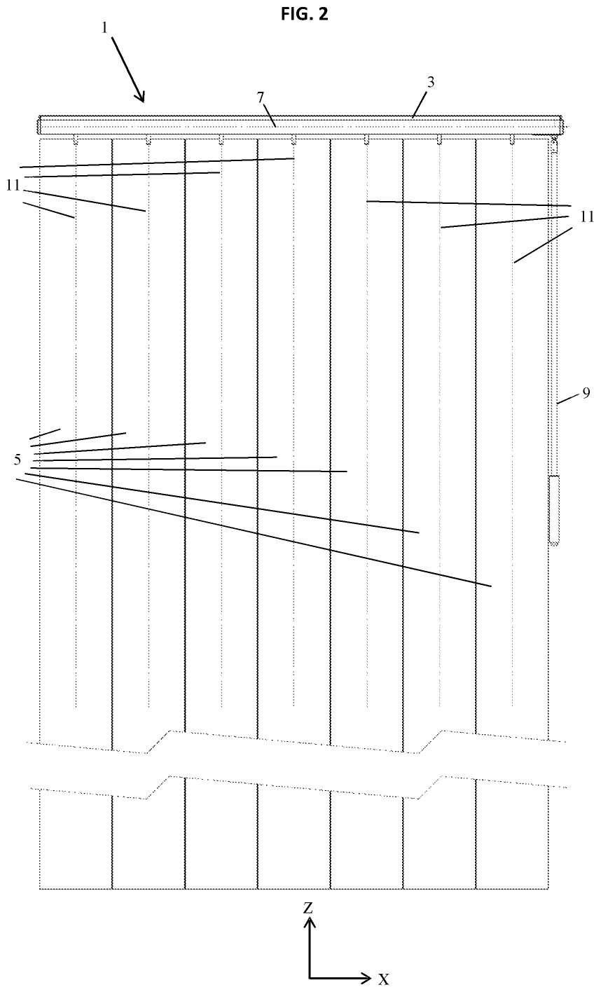

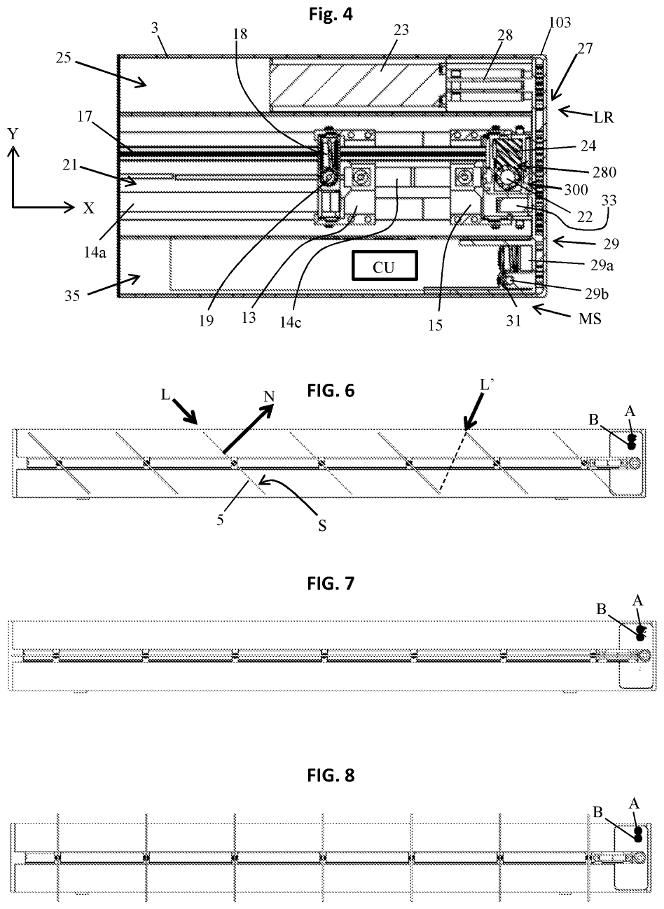

FIG. 1 depicts a front view with the lamellae 5 in an open position. FIG. 2 depicts a front view with the lamellae 5 in a closed position in which the lamellae are distributed substantially evenly along the rail 3. FIG. 3 depicts a cross sectional bottom view of the rail 3 with the Z-direction being perpendicular to the plane of the drawing. FIG. 4 depicts in more detail a first side FS of the rail 3 in the cross sectional view of FIG. 3. FIG. 5 depicts a cross sectional view of the rail 3 with the X-direction being perpendicular to the plane of the drawing. FIGS. 6, 7 and 8 depict bottom views of the system 1 with the lamellae in the closed position but in different angular orientations about the Z-axis.

The lamellae 5 are supported by corresponding lamellae support members 13, which are moveably connected to the rail 3 allowing to move the lamellae support members 13 along the rail 3 parallel to a longitudinal axis 7 of the rail between an open position in which the lamellae 5 are stacked together as shown in FIG. 1 and a closed position as shown in FIG. 2 in which the lamellae 5 are distributed substantially evenly along the rail 3. It is explicitly noted here that there may be a plurality of different open positions. In FIG. 1, the lamellae are in a completely open position, i.e. all the lamellae 5 are stacked together. However, other open positions, in between the completely open position and the closed position, with only a portion of the lamellae being stacked together, also exist.

In this embodiment, the lamellae 5 are all stacked together at a second side SS of the rail 3 in the completely open position. The lamellae support members are connected to adjacent lamellae support members using connection elements 14a, which elements allow the lamellae support members to get close to each other as shown in FIG. 1, but set a maximum distance between the lamellae support members 13. Connection elements 14a may alternatively be referred to as spacers. Hence when moving the lamellae support members 13 from the completely open position of FIG. 1 to the closed position of FIG. 2, the rightmost lamellae support member 13 will move first until the distance between the rightmost lamellae support member 13 and the next lamellae support member reaches the maximum distance set by the connection element 14a after which the next lamellae support member 13 will be dragged along. This process will repeat itself until all lamellae support members 13 have been distributed along the rail 3.

The leftmost lamellae support member 13 is connected to the rail 13 via a connection element 14b, which may alternatively be referred to as start-spacer. This connection element 14b may be a rigid connection, meaning that the leftmost lamellae support member 13 has a fixed position relative to the rail 13, but in this embodiment, the connection element 14b is similar to the connection elements 14a in that it allows the leftmost lamellae support member 13 to get close to the second side SS of the rail 3 in order to get a stack of lamellae 5 in the open position which is positioned as much to the left, i.e. the second side SS of the rail 3, as possible.

The rightmost lamellae support member 13 is rigidly connected via connection element 14c to an operating support member 15, which in turn is movably connected to the rail in a similar manner as the lamellae support members 13 to move along the rail. Connection element 14c may alternatively be referred to as end-spacer. The operating support member 15 carries a manual operating member 9 allowing a user to move the operating support member 15 along the rail 3 thereby being able to move the lamellae support members between the open and closed positions.

At the first side FS of the rail 3, as most clearly depicted in FIG. 4, a measurement system MS, a control unit CU, and a lamellae rotating actuator system LR are provided. Visible in FIG. 4 are also the aforementioned operating support member 15, the rightmost lamellae support member 13, the connection element 14c in between them, and the connection element 14a connecting the right most lamellae support member 13 to the next lamellae support member 13 (not visible in FIG. 4), which are all arranged inside a space 21 of the rail 3.

Also arranged inside space 21 is a lamellae support member engaging element 17 extending parallel to the longitudinal axis 7 of the rail 3 between the first side FS of the rail 3 and the second side SS of the rail 3. The engaging element 17 is rotatable about its longitudinal axis. Each lamellae support member 13 comprises a worm screw 18 as part of a worm drive, which worm screw 18 engages with but can easily translate along the engaging element 17 without rotation, but rotation of the engaging element 17 about its longitudinal axis will rotate the worm screw 18 as well.

The worm screw 18 is operably connected to a worm gear 19 as the other part of the worm drive, so that rotation of the worm screw 18 caused by rotation of the engaging element 17 results in rotation of the worm gear 19 about an axis extending parallel to the Z-direction, in this case about a longitudinal axis 11 of a corresponding lamella 5. In this embodiment, the worm gear 19 is an integral part of a support clip 20 engaging with the respective lamella 5 as can be seen more clearly in FIG. 5, but the worm gear 19 and the support clip 20 may also be separate parts that are assembled together, i.e. connected to each other during assembly instead of being manufactured as a single element.

The operating support member 15 in this embodiment comprises two helical gears 22, 24. The helical gear 22 is connected to the manual operating member 9 and operably connected to the helical gear 24. The helical gear 24 engages with but can easily translate along the engaging element 17 without rotation, but rotation of the helical gear 24 will cause rotation of the engaging element 17. Hence, by rotating the operating member 9 about its longitudinal axis, and thus rotating the helical gear 22, the helical gear 24 is caused to rotate, and thus engaging element 17 is caused to rotate, which in turn will rotate the support clip 20 via the worm screw 18 and worm gear 19 of each lamellae support member 13 resulting in rotation of the lamellae 5 about their longitudinal axes 11.

Hence, the operating member 9 can be used to translate the lamellae 5 along the rail 3 and can be used to rotate the lamellae 5 about their longitudinal axes 11.

The engaging element 17 is further connected via a gear arrangement 27 to an electric motor 23 arranged inside space 25 of the rail 3. Hence, the engagement element 17 can also be rotated using the motor 23.

In addition, the engaging element 17 is connected via a gear arrangement 29 to the measurement system MS, which measurement system MS comprises an absolute rotary encoder 31. The gear arrangement 29 in this embodiment comprises a worm drive including a worm screw 29a and a worm gear 29b, mimicking the worm drive 18,19 of a lamellae support member, so that the gear ratio of the gear arrangement 29 is preferably such that the angular orientation of the lamellae 5 can be determined from an output signal of the rotary encoder 31. This preferably means that 360 degrees of rotation of the lamellae 5 corresponds to 360 degrees of rotation of the shaft of the gear connected to the rotary encoder. In an embodiment, the worm gear 29b comprises a magnet and the measurement system MS comprises a magnetic absolute encoder measuring the orientation of the magnetic field applied by the magnet.

The system 1 further comprises a detector 33 to detect the presence of the operating support member 15. This presence can only be detected when the operating support member 15 is in the position as shown in FIG. 4, so that the presence of the operating support member 15 is an indication that the lamellae support members 13 and thus the lamellae 5 are in the closed position of FIG. 2. In an embodiment, the detector 33 is a Hall sensor suitable to detect the presence of a magnetic field caused by a permanent magnet arranged in or on the operating support member 15.

The measurement system MS, i.e. rotary encoder 31, the detector 33, and the electric motor 23 are connected to the control unit CU, which control unit CU is arranged in space 35 of the rail along with the rotary encoder 31. The control unit CU is configured to drive the electric motor 23 based on a comparison between the actual angular orientation of the lamellae 5 as measured by the rotary encoder 31 and a desired angular orientation of the lamellae 5 as determined by the control unit CU based on a position of the sun and/or intensity of light.

The rail 3 may be connected to a ceiling or any other overhead structure using one or more, preferably at least two or three clips 37 as shown in FIG. 5, wherein the rail 3 may comprise a T-profile 38 at each side on top of the rail 3 that engages with the clip 37. The clip 37 itself is mounted to the ceiling or overhead structure using for instance a screw 39. Once the plurality of clips, the number clips depending amongst other on the length of the rail 3 and the weight of the system, have been mounted to the ceiling or overhead structure, the rail 3 can simply be clicked into engagement with the clip 37. An advantage of using clips is that the rail and thus the system can also be removed relatively simple, e.g. for maintenance or repair.

Between the clip 37 or ceiling/overhead structure and the rail 3, two spaces 41, 43 are provided allowing to hide wiring that extends between the first side FS of the rail 3 and the second side SS of the rail 3 for the transfer of power and/or data as will be explained in more detail below.

FIG. 5 also clearly depicts a groove or recess 45 in the rail 3 for receiving an extension 47 of a lamellae support member 13. The extension 47 may extend away from the lamellae support member 13 in a direction parallel to the longitudinal axis 7 of the rail 3. The groove 45 and extension 47 cooperate in guiding the movement of the lamellae support member 13 and prevent undesired rotation of the lamellae support member 13 about an axis parallel to the Z-direction.

The control unit CU may comprise different modes and functions, some of which will be described below by reference to the drawings.

For instance, the control unit CU may comprise a setup mode in which the control unit is configured for operation. The setup mode is especially important when the control unit determines a position of the sun based on time, date, orientation of the system relative to the sun and the geographical location of the system.

In an embodiment, the control unit comprises a GPS device allowing the system to accurately determine its geographical location, but also the time and date if the GPS signal contains a timestamp as well. Alternatively, the time, date and/or geographical location may be inputted to the control unit manually and/or using external communication/connection.

When the geographical location, time and date are known, independent of how, the only remaining parameter to determine the location of the sun is the orientation of the system. In setup mode, the control unit CU may be configured to determine or receive information about the geographical location, time, date and orientation of the system. For determining the latter, the system may be provided with two pushbuttons A, B as depicted in FIGS. 6-8. Pushbutton A may be configured to drive the electric motor 23 to rotate the lamellae about their rotation axes 11, in this embodiment coinciding with their longitudinal axes. The lamellae can then be positioned towards the sun, meaning that a normal N to a surface S of a respective lamella 5 points towards the sun in plan view. An example thereof is shown in FIG. 6. If the lamellae are facing the sun, this position can be confirmed by pressing pushbutton B. The control unit CU in the setup mode is then able to determine the orientation of the system from the angular orientation of the lamellae, the time, the date and the geographical location of the system. The orientation may also be provided manually and/or using external communication/connection to the control unit.

The control unit CU further comprises a main automatic mode in which the control unit CU is configured to autonomously drive the lamellae rotating actuator system, i.e. electric motor 23. The control unit CU is configured to operate in the main automatic mode provided the detector 33 indicates that the lamellae support members 13 are in the closed position of FIG. 2 and there is no indication from the measurement system MS, i.e. in this embodiment rotary encoder 31, that the lamellae 5 have been rotated by a user since the lamellae support members 13 have been positioned in the closed position.

In the main automatic mode, the control unit CU may have a blocking function in which the control unit CU is configured to drive the lamellae rotating actuator system LR such that the lamellae 5 are directed towards the sun. This is alternatively referred to as tracking the sun or solar tracking. In this mode the lamellae 5 always face towards the sun, so that direct sun light is effectively blocked. This situation is for instance indicated in FIG. 6 when the sun is located in the direction of arrow N. Blocking of sunlight with the lamellae facing towards the sun may be advantageous to effectively reflect light and heat.

In the main automatic mode, the control unit CU may have a heating function in which the control unit CU is configured to drive the lamellae rotating actuator system LR such that the lamellae 5 are parallel to the sunlight. An example thereof is indicated in FIG. 6 in case the sun is at a location such that the sunlight travels in a direction parallel to arrow L and thus parallel to the lamellae 5. In this way of tracking the sun, maximum light is allowed to enter a building, room or space, thereby allowing to harvest a maximum of solar heat in the building, room or space, e.g. in the winter. This heating function is preferably activated when there are no users in the building, room or space, e.g. in a weekend for office buildings, so that this function does not interfere with occupants' comfort. It is also possible to connect the control unit to a motion detector or similar sensor to detect the presence of people and thus to determine whether the heating function can be activated or not.

In the main automatic mode, the control unit CU may have a maximum view function in which the control CU is configured to drive the lamellae rotating actuator system such that direct sunlight is prevented from passing the lamellae while at the same time the shadow of a lamella on an adjacent lamella is minimized to get a maximum view in between the lamellae. An example thereof is indicated in FIG. 6 in case the sun is at a location such that the sunlight travels in a direction parallel to arrow L′ without passing the lamellae, but with minimal shadow on the lamellae caused by adjacent lamellae.

In this embodiment, in the closed position, the distance between adjacent lamellae support members is (preferably slightly) larger than the width of a lamella, so that the lamellae are able to rotate freely about their rotation axis. Hence, the lamellae 5 are able to rotate 360 degrees without interfering with each other. In such situation, the control unit CU is able to rotate the lamellae in the main automatic mode such that in any angular orientation the same side of the lamellae can face towards the sun. This embodiment thus allows to use lamellae with different sides that each can be faced towards the sun during the whole length of day, e.g. a reflective side to be used in the summer to reflect light for cooling purposes and e.g. an absorbing side to be used in the winter to absorb light for heat harvesting purposes.

When alternatively, in the closed position, the distance between adjacent lamellae support members is (preferably slightly) smaller than the width of a lamella, the lamellae are not able to freely rotate about their rotation axis. Hence, the lamellae are able to maximally rotate about 180 degrees before interfering with each other. In such situation, the control unit CU is configured to rotate the lamellae in the main automatic mode such that they do not interfere with each other. Hence, when tracking the sun, the lamellae may be rotated to a position in which they are nearly parallel to each other. When the lamellae then should be rotated further to keep following the sun, the control unit CU instead drives the lamellae rotating actuator system such that the lamellae are rotated back about 180 degrees and are able to follow the sun again without interference.

The control unit CU may further comprise a manual mode in which the control unit is idle, meaning that the lamellae rotating actuator system is not driven by the control unit and that rotation of the lamellae is only possible using the operating member, i.e. the control unit CU refrains from sending driving signals to the lamellae rotating actuator system. The control unit is not prohibited from receiving and sending other signals and may thus still be active.

The control unit CU may be configured to switch from main automatic mode to manual mode upon manual operation using the operating member 9. Hence, either by moving the lamellae from the closed position to an open position as will be indicated by detector 33, or by rotating the lamellae 5 using the operating member 9. Switching back from manual mode to main automatic mode may be done automatically for instance once a day, preferably during the night, when a reset command is send through external device/communication, or when a predetermined time period has passed. Alternatively or additionally, the user may indicate that the main automatic mode may be resumed using the detector 33. When the lamellae have been moved to an open position to activate the manual mode, the main automatic mode is resumed when the lamellae are moved back to the closed position as will be detected by the detector 31. When the lamellae have been rotated to activate the manual mode, the main automatic mode may be resumed by moving the operating support member 15 first away from the detector and subsequently back into the closed position.

The control unit CU may alternatively be configured to switch from main automatic mode to manual mode only when the lamellae are manually rotated. Moving the lamellae to an open position, including any open position in between the closed position of FIG. 2 and the fully open position of FIG. 1, will then cause the control unit to switch to another mode not being the manual mode.

The mentioned other mode may be an auxiliary automatic mode in which the control unit is configured to autonomously drive the lamellae rotating actuator system, wherein the control unit is configured to operate in the second automatic mode provided that the detector indicates that the lamellae support members are in an open position and there is no indication from the measurement system that the lamellae have been rotated manually since the lamellae support members have been positioned in the open position, and wherein the control unit in the auxiliary automatic mode is configured to drive the lamellae rotating actuator system such that the lamellae do not interfere with each other.

When the lamellae in the closed position are not able to freely rotate, the control unit in the main automatic mode is configured to drive the lamellae rotating actuator system such that the lamellae do not interfere with each other and there may be no distinction between main and auxiliary automatic mode, at least the main and auxiliary automatic mode may be very similar. In such a case, a single automatic mode performing both as main and auxiliary automatic mode so that there is no distinction between the main and auxiliary automatic mode other than that the lamellae are in the closed position or in an open position also falls within the scope of the invention.

However, as in the embodiment of FIGS. 1-8, the lamellae in the closed position are able to freely rotate, so that a clear distinction exists between the main automatic mode and the auxiliary automatic mode, namely that in the auxiliary automatic mode the lamellae rotating actuator system is driven such that the lamellae do not interfere with each other while this is not necessary in the main automatic mode.

One or more of the earlier described blocking function, heating function and maximum view functions may be available in the auxiliary automatic mode as well.

Another mentioned other mode may be a user control mode in which the lamellae rotating actuator is controllable based on user input provided via an electronic control interface and is controllable via manual operation of the operating member 9. Hence, in user control mode, driving signals may still be send by the control unit to the lamellae rotating actuator system to rotate the lamellae support members. Such user input may be provided using a wired or wireless control interface connected to the control unit. For instance, wall switches or remote control can be used, but also remote control using mobile devices such as a tablet or smartphone.

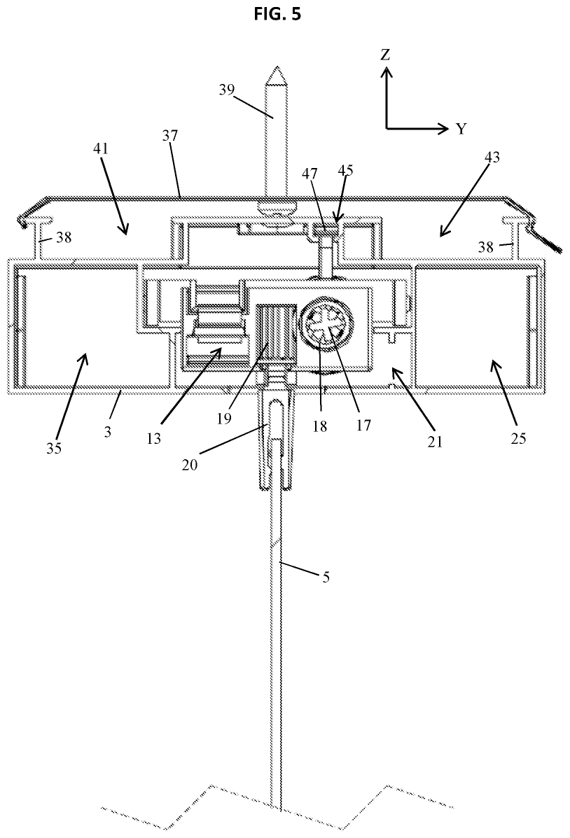

Although not shown, the system may comprise or be connected to a solar cell arranged to determine an outdoor light level. This allows to have an open function besides the blocking function. In that case, the main automatic mode and the auxiliary automatic mode, if applicable, may be configured to use the blocking function when the outdoor light level is above a predetermined value in order to block direct sunlight from entering a building, space or room. Further, the main automatic mode and the auxiliary automatic mode, if applicable, may be configured to use the open function when the outdoor light level is below a predetermined value. In the open function, the lamellae may be rotated to an angular orientation in which the lamellae are perpendicular to the longitudinal axis 7 of the rail 3 as shown in FIG. 8.

The use of a solar cell arranged to determine an outdoor light level also allows to have a night function besides the blocking function. In that case, the main automatic mode and the auxiliary automatic mode, if applicable, may be configured to use the blocking function when the outdoor light level is above a predetermined value in order to block direct sunlight from entering a building, space or room during the day. Further, the main automatic mode and the auxiliary automatic mode, if applicable, may be configured to use the night function when the outdoor light level is below a predetermined value. In the night function, the lamellae may be rotated to an angular orientation in which the lamellae are parallel to the longitudinal axis 7 of the rail 3 as shown in FIG. 7.

The blocking function, open function and night function may also be combined, so that the blocking function is used when the outdoor light level is above a first predetermined value, the maximum view function is used when the outdoor light level is between a second predetermined value and the first predetermined value, and the night function is used when the outdoor light level is below the second predetermined value.

Referring to FIG. 4 again, the lamellae rotating actuator system comprises a decoupler 28 in between the motor 23 and the gear arrangement 27. In this embodiment, decoupler 28 is the only decoupler provided in the lamellae rotating actuator system, so that the lamellae 5, the lamellae support member engaging element 17, the gear arrangement 29 and the measurement system thus all have a fixed angular orientation relative to each other. The decoupler 28 in this embodiment may have two functions:
1. providing a decoupling possibility between engaging element 17 and the motor 23, i.e. between the lamellae 5 and the motor 23 to prevent damage to the lamellae 5 when they interfere with each other or with other objects while the motor is rotating them; and
2. providing a decoupling possibility between operating member 9 and the motor 23 to make manual operation require a limited torque, i.e. make manual operation easy for a user.

In an embodiment, another decoupler 280 may be provided between the operating member 9 and the helical gear 22 or between the helical gear 24 and the engaging element 17 to provide a decoupling possibility between engaging element 17 and the operating member 9 to prevent damage to the lamellae 5 when they interfere with each other or with other objects while the operating member is rotating them.

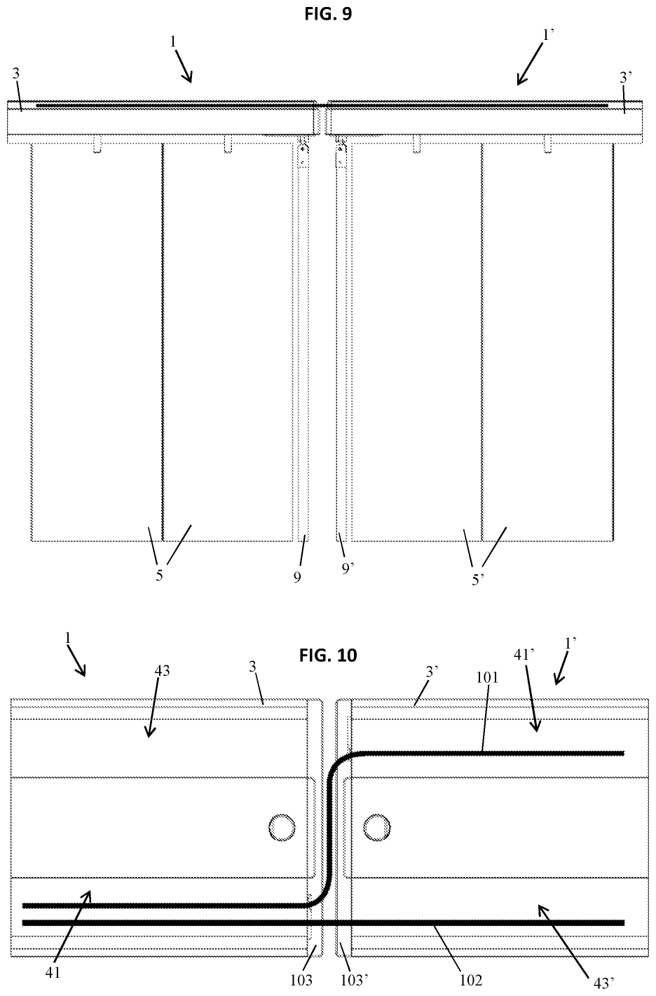

FIG. 9 depicts a schematic front view of two light regulating systems according to FIGS. 1-8 being arranged next to each other. To distinguish between the two light regulating systems, the left system will be referred to using the same reference symbols as used in FIGS. 1-8 and the right system will be referred to using similar reference symbols with an additional apostrophe. Hence, on the left a light regulating system 1 is depicted partially and on the right a light regulating system 1′ is also depicted partially.

Shown in FIG. 9, in relation to light regulating system 1, are the rail 3, lamellae 5 and operating member 9. Further shown in FIG. 9, in relation to light regulating system 1′, are the rail 3′, lamellae 5′ and operating member 9′.

The light regulating systems 1′ and 1′ are thus mirrored with respect to each other so that the operating members 9, 9′ are positioned close to each other. In this way, a user is able to operate two systems at one location. Preferably, the rails 3,3′ are positioned as close to each other as possible to minimize the space between the rightmost lamella 5 of the system 1 and the leftmost lamella 5′ of the system 1′.

FIG. 10 depicts in more detail a schematic top view of the view of FIG. 9. FIG. 10 depicts the rails 3, 3′ with spaces 41 and 43 in rail 3 and spaces 41′ and 43′ in rail 3′. Due to the mirrored orientation, the spaces 41 and 43′ are aligned with each other as are the spaces 41′ and 43.

The respective ends of the rails 3, 3′ are provided with end caps 103, 103′ protecting the equipment inside the rail 3, 3′ and possibly carrying components, e.g. the gear arrangements 27 and/or 29. The end caps may also allow for the guiding of wiring, e.g. between the control unit and the motor, but in this case also allow wiring to extend from one system 1 to another system 1′ thereby allowing to provide power and/or data transfer via another system. As an example, wiring 101 extends from space 41 of system 1 to space 41′ of system 1′. As another example, wiring 102 extends from space 41 of system 1 to space 43′ of system 1′.

Although in the embodiments of FIGS. 9 and 10, the end caps 103 and 103′ do not touch each other and wiring 101 runs in between the two end caps, it is also possible that the ends caps 103, 103′ are arranged directly next to each other and the wiring 101 extends through the end caps 103, 103′. The advantage is that the distance between the rightmost lamella 5 of the system 1 and the leftmost lamella 5′ of the system 1′ can be further decreased. Hence, preferably a thickness of the end caps 103, 103′ is minimal.

Referring back to FIG. 4, the rail 3 of this embodiment may also comprise an end cap 103, which end cap may be configured to support one or more of the following components, preferably all of the following components:
motor 23;
decoupler 28;
gear arrangement 27;
gear arrangement 29;
detector 33;
measurement system MS; and
control system CU.

The dimension of the end cap 103 that extends beyond the rail 3 is preferably only determined by a wall thickness of the end cap 103 and a thickness of the gears of the gear arrangements 27 and 29, which thicknesses are preferably minimized.

In an embodiment, the motor 23 is connected to the end cap 103 using a damping element or damping material, so that vibrations caused by the motor are attenuated before reaching the rail 3 via the end cap 103.

Also shown in FIG. 4 is a retainer 300, in this embodiment a permanent magnet, configured to apply a biasing force to the lamellae support members 13 when the lamellae support members 13 are in the closed position as shown in FIG. 4. The retainer 300 is arranged on the end cap 103 and cooperates with a magnetic material in the operating support member 15 to apply a biasing force between the operating support member 15 and the end cap 103, which is transferred to the lamellae support members 13 via the connection elements 14b and 14c.

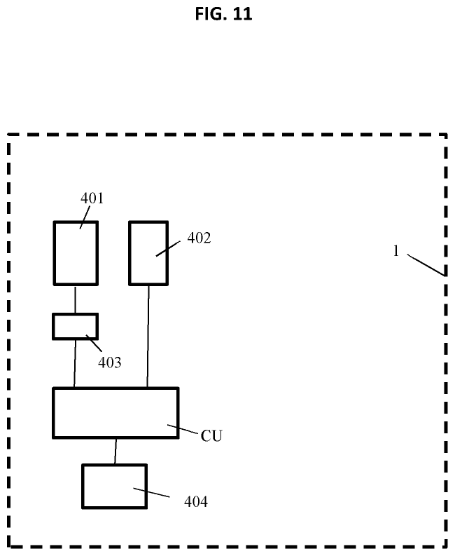

FIG. 11 schematically depicts a light regulating system 1 according to another embodiment of the invention. The light regulating system 1 may be similar or identical to the above described systems and includes a control unit CU. The system 1 of FIG. 11 additionally comprises a solar cell 401 to harvest power from light incident to the solar cell 401, and a battery 403 to store power from the solar cell 401 in order to provide power to the system 1 in this case via the control unit CU.

The system 1 further comprises a solar cell 402 to measure light intensity. In an embodiment, the solar cell 402 is omitted and the solar cell 401 is also used to measure light intensity. By measuring the intensity of solar irradiance as well as a detection of low-light levels, i.e. absence of direct incident light, it is possible to let the control unit CU automatically determine that blocking of light is necessary or not and thus in case of low-light levels allows to rotate the lamellae to a position to allow maximum view and daylight.

The system 1 further comprises a communication unit 404 connected to the control unit CU to allow communication, preferably wirelessly, between the control unit and an external device, e.g. an electronic user interface, a monitoring system, a server, a remote control or any other kind of device, including but not limited to smartphones, tablets, computers, etc.

It will be apparent to the skilled person that the above described embodiments are merely exemplary for the invention. Parameters such as dimensions, e.g. the length of the rail and the length and width of the lamellae, and for instance the number of lamellae used may vary and are not essential to the invention.

1. A light regulating system comprising:
a rail, in use extending in horizontal direction (X);
a plurality of lamellae, in use extending in vertical direction (Z);
lamellae support members to support the plurality of lamellae, wherein the lamellae support members are movably connected to the rail allowing to move the lamellae support members along the rail parallel to a longitudinal axis of the rail between an open position in which the lamellae support members are stacked together and a closed position in which the lamellae support members are distributed substantially evenly along the rail, and wherein each lamellae support member is attached to a corresponding lamella such that the respective lamella can rotate relative to the rail about a rotation axis extending parallel to a longitudinal axis of the lamella;
a lamellae rotating actuator system configured to rotate the lamellae about their respective rotation axes;
a measurement system configured to measure an actual angular orientation of the lamellae about their respective rotation axes;
a detector configured to detect whether or not the lamellae support members are in the closed position;
a control unit configured to drive the lamellae rotating actuator system based on a comparison of the actual angular orientation of the lamellae as measured by the measurement system and a desired angular orientation of the lamellae as determined by the control unit based on a position and/or intensity of the sun;
wherein an operating member is connected to the lamellae rotating actuator system to allow rotation of the lamellae about their respective rotation axes by manual operation of the operating member;
wherein the detector and the measurement system are connected to the control unit;
wherein the control unit comprises a main automatic mode in which the control unit is configured to autonomously drive the lamellae rotating actuator system,
and wherein the control unit is configured to operate in the main automatic mode provided that the detector indicates that the lamellae support members are in the closed position and there is no indication from the measurement system that the lamellae have been rotated manually since the lamellae support members have been positioned in the closed position.

2. A system according to claim 1, further comprising a retainer configured to apply a biasing force to the lamellae support members when the lamellae support members are in the closed position.

3. A system according to claim 1, wherein the lamellae rotating actuator system comprises a motor and a lamellae support member engaging element connected to the motor and engaging with the lamellae support members, and wherein the operating member is connected to the lamellae support member engaging element, such that the lamellae support member engaging element can be driven to rotate the lamellae support members via the motor and via the operating member.

4. A system according to claim 3, wherein the lamellae rotating actuator system comprises a decoupler configured to decouple the operating member from the motor when operating the operating member manually.

5. A system according to claim 3, wherein the lamellae rotating actuator system comprises a decoupler configured to decouple the lamellae support member engaging element from the motor and/or the operating member when a predetermined torque is applied to the decoupler.

6. A system according to claim 1, wherein the system further comprises a solar cell to harvest power from light incident to the solar cell, and a battery to store power from the solar cell in order to provide power to the system.

7. A system according to claim 1, wherein the system comprises a solar cell to measure light intensity.

8. A system according to claim 1, wherein the lamellae are able to rotate 360 degrees about their respective rotation axis without interfering with neighboring lamellae in the closed position of the lamellae support members.

9. A system according to claim 1, wherein the operating member is a stick with one end connected to the lamellae rotating actuator system and with the opposite end being free for user operation, wherein the free end comprises an intermediate portion and an end portion, wherein the intermediate portion is rotatably connected to the remainder of the operating member to rotate about a first rotation axis, and wherein the end portion is rotatably connected to the intermediate portion to rotate about a second rotation axis, in which the first and second rotation axis are parallel to each other, and in which the operating member has a rest position in which the operating member has a stick shape, and an operating position in which the intermediate portion is rotated substantially perpendicular to the remainder of the operating member and the end portion is at a distance of and substantially parallel to the remainder of the operating member thereby allowing to apply a larger moment to the operating member via the end portion.

10. A system according to claim 1, wherein the operating member is further arranged to manually move the lamellae support members between open and closed positions.

11. A system according to claim 3, wherein a damping element or material is arranged between the motor of the lamellae rotating actuator system and the rail to attenuate vibrations originating from the motor and travelling to the rail.

12. A system according to claim 1, wherein the system further comprises connecting members allowing to exchange power and/or data with another system according to claim 1.

13. A system according to claim 1, wherein the system further comprises a communication unit (404) connected to the control unit to allow communication, preferably wirelessly, between the control unit and an external device, e.g. an electronic user interface, a monitoring system, a server, a remote control or any other kind of device, including but not limited to smartphones, tablets, computers, etc.

14. A combination of at least two light regulating systems according to claim 1, wherein at least one light regulating system carries a cable for transferring power and/or data to at least one other light regulating system.

15. A method for operating a light regulating system according to claim 1, comprising the following steps:
a) operating the control unit in the main automatic mode;
b) detecting manual operation of the lamellae rotating actuator system; and
c) subsequently cease operating the control unit in the main automatic mode.
